(19) United States
(12) Patent Application Publication
(10) Pub. No.: US 2023/0318868 A1
(43) Pub. Date: Oct. 5, 2023

(54) Identifying an Electronic Device Connected to an Electrical Power Source

(71) Applicant: Source to Site Accessories Limited, St. Albans (GB)

(72) Inventors: Michael Dangoor, St Albans Hertfordshire (GB); Michael James Godfrey, St Albans Hertfordshire (GB); Loong Yen Johann Siau, St Albans Hertfordshire (GB)

(21) Appl. No.: 18/043,800

(22) PCT Filed: Sep. 3, 2021
(86) PCT No.: PCT/GB2021/052281

§ 371 Date: Jul. 19, 2023

(30) Foreign Application Priority Data
Sep. 4, 2020 (GB) 2013953.1

(51) Int. Cl. H04L 12/28; H02J 7/00; G06F 13/42

(52) U.S. Cl. CPC H04L 12/2807; G06F 13/4282; H02J 7/00034; H02J 7/0048; G06F 2213/0042

(57) ABSTRACT

Identifying an Electronic Device Connected to an Electrical Power Source A system and apparatus for identifying an electronic device connected to an electrical power source. The apparatus has an interface configured to receive electrical power from an electrical power source. The interface is connectable to an electronic device to provide electrical power from the electrical power source to the electronic device, and receive data from the electronic device. The data received from the electronic device includes identification information to identify the electronic device. The apparatus has a communication device configured to send the identification information to the remote host. The remote host has a communication device configured to receive the identification information about the electronic device connected to the interface. The remote host has a processor configured to generate a control signal configured to control the identified electronic device, where the control signal is generated based on the identification information associated with the identified electronic device. The apparatus has a switch configured to control a supply of electrical power to the identified electronic device based on the control signal.

### FIELD OF THE INVENTION

The invention relates to a system and an apparatus for identifying an electronic device connected to an electrical power source.

### BACKGROUND OF THE INVENTION

It can be useful to identify specific electrical devices connected to electrical power outlets (or other electrical power sources) around a building. For example, identifying that a hairdryer is being used from an electrical power outlet in a bedroom, or a television is being used from an electrical power outlet in a living room. Once identified, information about the usage and behaviour of the specific devices may be collected and operation of the specific devices may be controlled (for example, allowing certain electrical devices to be used while prohibiting others).

One way to identify an electrical device connected to an electrical power outlet is using a characteristic electrical signature that the electrical device imprints on the electrical supply to the electrical device, comparing a recorded electrical signature against electrical signatures of known electrical devices recorded in a database to identity the electrical device connected to the electrical power outlet.

The use of electrical signatures works well for many electrical devices which connect directly to an alternating current mains electricity supply and imprint a fairly unique electrical signature on that supply. However, electrical signatures are less suited to electronic devices, such as smartphones, tablets are other electronic device. These electronic devices tend to be powered/charged by external transformers or power supplies that reduce the mains voltage to a voltage suitable for powering/charging the electronic device. Therefore, the electrical signature tends to be characteristic of the transformer or power supply powering/charging the electronic device, rather than the electronic device itself. That is, the electrical signature may identify that a particular type of transformer or power supply is powering/charging the electronic device, but not identify the electronic device itself. As a result, where the same type of transformer or power supply is used to power different electronic devices, it may not be possible to distinguish between the actual electronic devices.

It would, therefore, be desirable to find an alternative way to identify electronic devices that are plugged into an electrical power outlet, particularly those powered by external transformers or power supplies.

### SUMMARY OF THE INVENTION

There is provided a system and an apparatus for identifying an electronic device connected to an electrical power source.

The system comprises the apparatus configured to communicate with a remote host.

The apparatus comprises an interface configured to receive electrical power from an electrical power source. The interface is connectable to an electronic device to: (1) provide electrical power from the electrical power source to the electronic device, and (2) receive data from the electronic device. The data received from the electronic device includes identification information which can be used to identify the electronic device. The apparatus further comprises a communication device configured to send the identification information to the remote host.

The remote host comprises a communication device configured to receive the identification information about the electronic device connected to the interface.

By connecting the electronic device to an interface that can (1) provide power and (2) receive data, such as a USB connection, the electronic device can be directly interrogated by the apparatus to determine the electronic device’s identity (for example, by reading one or more device identifiers). This overcomes the problem of how to uniquely identify electronic devices connected to an electrical power source, and avoids problems associated with using electrical signatures which might only identify the transformer or power supply. By reporting the identity information to a remote host, powering/charging of the identified electronic device can be remotely monitored and controlled.

In order to obtain identifying information from the electronic device, the interface may be configured to emulate a computer thereby causing an electronic device to identify itself when connected to the interface in the way the electronic device would identify itself when connected to a computer. The interface may be configured according to a standard for connecting an electronic (for example, peripheral) device to a computer. The identification information comprises a device identifier for identifying the electronic (for example, peripheral) device to a computer according to the standard. In one example, the standard is a Universal Serial Bus (USB) standard, the interface comprises a USB connector, the interface is configured to emulate a USB host and the identification information comprises a device descriptor according to the USB standard. The interface could be configured to any other standard (or standards) that allow data and power to be transferred (such as Power over Ethernet).

The interface may communicate with the remote host over a wired or wireless communications network.

The system may comprise a plurality of apparatuses. The plurality of apparatuses may be distributed around an electrical network, such as distributed around the electrical network associated with a building, dwelling or premises. For example, the plurality of apparatuses may be electrical outlets (or adapters connected to electrical outlets) distributed around different rooms or other locations in or around a building. Each apparatus of the plurality of apparatuses may communicate with the remote host, sending identification information about any connected electronic device to the remote host such that a specific electronic device connected to any of the plurality of apparatuses may be remotely monitored and controlled.

The remote host may be one or more of: in the same building or premises as the interface, connected to the same local network as the interface, on a central server serving interfaces in multiple locations, connected to the interface over a wide area network, and in the cloud The system may further comprise a hub configured to relay the identification information to the remote host. The hub may be located in the same building or premises as the interface or connected to the same local network.

The remote host may comprise a processor configured to generate a control signal configured to control an identified electronic device. The apparatus may further comprise a switch configured to control a supply of electrical power to the identified electronic device based on the control signal. The control signal may be generated based on the identification information associated with the identified electronic device. That is, the control signal may take account of the identity of the electronic device and use this determined identity to decide whether to permit (allow or disallow) operation of the electronic device, or whether to place certain conditions on the use of the electronic device (such as only permitting use for a certain length of time). These conditions may be governed by one or more policies.

The remote host may comprise a computer-readable storage medium configured to store a policy database comprising a policy associated with the identified electronic device and/or a policy associated with a class of electronic devices to which the identified electronic device belong. The control signal may be generated based on the policy.

The policy associated with the identified electronic device or class of electronic devices to which the identified electronic device belongs may determine at least one of: whether operation is allowed or disallowed; a length of time for which operation is allowed; a time of day and/or day of the week during which operation is allowed; and an operation based on the status of the identified electronic device.

In the event that the policy indicates that operation of the identified electronic device or class of electronic devices to which the identified electronic device belongs is allowed, the control signal may be configured to enable the switch in the interface to supply electrical power to the identified electronic device. In the event that the policy indicates that operation of the identified electronic device or class of electronic devices to which the identified electronic device belongs is disallowed, the control signal may be configured to disable the switch in the interface to prevent the supply of electrical power to the identified electronic device.

The data received from the electronic device may include information about the status of the electronic device. The control signal may be generated based on the status of the electronic device.

The status may comprise a charging state of a battery of the electronic device and/or a level of charge of the battery, optionally the control signal may be generated based on the charging state and/or level of charge.

The control signal may be configured to disallow operation of the electronic device in response to the interface receiving no identification information from the electronic device.

The apparatus may be configured to determine an electrical demand profile of the electronic device connected to the interface. The communication device of the apparatus may send the electrical demand profile to the remote host. The remote host may identify the electronic device based on the electrical demand profile. The electrical demand profile may comprise an instantaneous current drawn by the electronic device from the interface, or a current drawn over a period of time. The electrical demand profile may be indicative of a charging profile of the electronic device. The electrical demand profile may be used as a way to determine the identity of electronic devices that do not send any identification information. Some electronic devices may be configured solely to receive power from the interface and may have no data connection to send identifying information (for example, a device configured for USB charging only, such as a portable battery pack).

The communication device of the interface may be configured to send an interface identifier to the remote host. The remote host may be configured to associate the identification information about the electronic device connected to the interface with the interface identifier. The interface identifier may be associated with a particular location in a building (such as a particular room or location in a room) to allow the location of the interface and devices connected thereto to be monitoring and reported (for example, to a user device).

A user device (such as a switch, a control panel, a portable electronic device, a computer, a tablet and a smartphone) may be configured to receive information about the identified electronic device from the remote host. In the case that data received from the electronic device includes information about the status of the electronic device, the user device may be configured to receive the status information from the remote host (for example, to allow a user to see which electronic devices are connected to which interfaces in which locations). The user device may generate a control signal configured to control the identified electronic device (for example, a user may enter instructions to control a particular electronic device or interface using the user device).

The interface may be located on a further electronic device (such as a computer, television or media device) that itself has an interface. For example, most computers include USB interfaces for connecting peripherals, and many televisions and media devices include USB interfaces for powering portable devices or receiving media data. The further electronic device can become part of the system which allows electronic devices connected thereto to be identified and controlled. The further electronic device may be configured to receive control signals from the remote host and control electrical power to its interface based on the control signals. New further electronic devices may be pre-configured (for example, at the factory) or an existing further electronic device may receive a software update (eg, via an app being installed from an app store on a smart TV). The software update may include instructions which reconfigure the further electronic device to allow it to control the electrical power to electronic devices connected to its interface based on the control signal from the remote host, thereby allowing the implementation on existing hardware.

The remote host may comprise a computer-readable storage medium configured to store a device database. The remote host may be configured to store, in the device database, data associated with electronic devices connected to the interface.

The data associated with electronic devices connected to the interface may include usage data, electrical demand profiles, charge/discharge profiles, records of control signals sent to the electronic devices, data received from electronic devices (including one or more of error messages, status information, battery status, and charging information), electronic device identifiers (including one or more of make, model, serial number, and user information), etc.

The remote host may store a record in the device database of identified devices that have been connected to the interface by storing identification information about the electronic device connected to the interface along with an associated interface identifier. The remote host may also store a record of each time an unidentified device has been connected to the interface.

The remote host may comprise a processor configured to execute an algorithm configured to generate predictions based on the data in the device database. The remote host may be configured to control devices connected to the system (such as the electronic device connected to the interface) based on the predictions.

Any or all of the data associated with electronic devices connected to the interface may be used to analyse and learn the behaviour and usage of the system, for example, to make predictions about future usage which can be used to control the system more intelligently. The predictions can be used to generate future actions and policies to control devices connected to the system, such as the electronic device connected to the interface. For example, where usage data shows that a particular electronic device is usually turned off at midnight, the electronic device may be turned off automatically whenever it has been left on after midnight.

The algorithms may involve statistical analysis, predictive algorithms, artificial intelligence, machine learning and the like. The data associated with electronic devices connected to the interface can provide training data for training a machine learning (or other artificial intelligence algorithm) to make predictions about future behaviour which can be used to operate electronic or other electrical devices connected to the system in an intelligent way

The remote host may collect data associated with electronic devices connected to interfaces located in multiple locations (such as different buildings or premises). For example, a hub in each location may collect data associated with electronic device connected to interface(s) located in that particular location and share this with a remote host in communication with hubs in some or all of the locations. The algorithm may generate predictions based on data collected from multiple locations in order to improve the quality of predictions (for example, by increasing the size of the dataset)

### BRIEF DESCRIPTION OF THE DRAWINGS

The invention shall now be described, by way of example only, with reference to the accompanying drawings in which:

FIG. 1 illustrates a system for identifying electronic devices which are connected to an electrical power source; and

FIG. 2 illustrates a system for identifying electronic devices which receive power from a further electronic device, such as a television.

### DETAILED DESCRIPTION

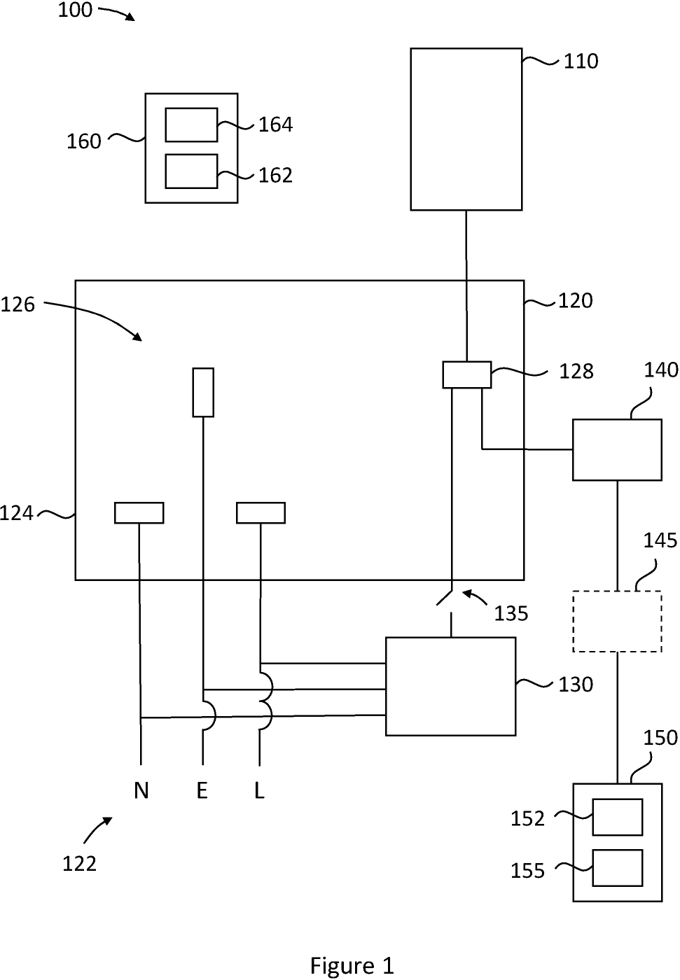

FIG. 1 illustrates a system 100 for identifying electronic devices which are connected to one or more electrical power sources (such as electronic devices plugged in to one or more electrical wall outlets 120 in a building). The system 100 communicates the identity of the connected electronic devices to a remote host 150 so that the identity of electronic devices using the electrical power source can be monitored and controlled.

In this example, the electronic device is a smartphone 110 which is connected to an electrical wall outlet 120 to receive electricity to power/charge the smartphone 110. The electrical wall outlet 120 is wired into a mains electricity supply 122 supplying the building where the electrical wall outlet 120 is located. The electrical wall outlet 120 has a faceplate 124 with one or more mains electricity sockets 126 configured according to local standards for plugging in mains powered electrical devices (such as household appliances, lights, televisions etc).

It is useful to be able to identify the specific electrical device connected to a particular mains electricity socket, for example, to allow specific electrical devices to be monitored and/or controlled remotely. An electrical device connected to the mains electricity socket 126 will modify the current waveform of the mains electricity supply 122 in a characteristic way, depending on the nature of the electrical and electronic components in the electrical device. This modified waveform can be used as an electrical signature which can be used to identify the electrical device, by comparing an electrical signature measured from the electrical device connected to the mains electricity socket 126 against a database of stored electrical signatures for known electrical devices.

However, a low voltage electronic device, such as smartphone 110, requires an external transformer or power supply to reduce the voltage of the mains electricity supply to a low voltage suitable for charging/powering the smartphone 110. Therefore, it is the external transformer or power supply used to power the electronic device that tends to imprint its characteristic signature on the electrical supply waveform, rather than the electronic device itself. Hence, attempts to identify the electronic device in this way tend to instead identify the external transformer or power supply being used to power/charge the electronic device rather than the electronic device itself.

Electronic devices, such as smartphone 110, are increasingly being provided with a USB interface for powering/charging the electronic device as well as providing a data connection for transferring data between the electronic device and other devices, such as a computer. Therefore, in common with an increasing number of electrical wall outlets, electrical wall outlet 120 includes a Universal Serial Bus (USB) interface 128 for powering/charging low voltage electronic devices, such as smartphone 110, to avoid the need for a separate external transformer or power supply. Instead, a suitable transformer or power supply 130 is incorporated into the back of the electrical wall outlet 120 to convert the mains electricity supply 122 into the low voltage required by the USB interface 128. The electrical signature of the smartphone 110 connected to the electrical wall outlet 120 over such a USB connection will be characteristic of the transformer or power supply 130, and will not provide a sufficiently distinctive signature that would identify the smartphone 110 itself.

Existing electrical wall outlets with USB outlets for powering/charging electronic devices provide only electrical power over the USB connection between the electrical wall outlet and the electronic device - they do not make use of the data connection that is also available over the USB connection. The inventors have realised that the USB data connection can be used to identify the electronic device itself, by reading one or more device identifiers when the electronic device is connected to the USB interface 128, thereby overcoming the problem of how to identify electronic devices connected to electrical wall outlet 120.

To allow the electrical wall outlet 120 to identify the smartphone 110, the USB interface 128 emulates a USB host operating according to the USB specification and initiates a USB connection process with the smartphone 110 when the smartphone 110 is connected to the USB interface 128. All USB devices have Device Descriptors which include information such as Vendor ID and Product ID which can be read by the USB host to identify a connected USB device. The USB interface 128 reads some or all of these Device Descriptors over the data connection and obtains the device identity by looking up the Device Descriptors in a database (such as one of the publicly available databases).

The interface has been described as being a USB interface 128. However, the interface could be configured according to any standard available now or in the future for connecting electronic (for example, peripheral) devices to a computer which can transmit identifying information about a connected electronic device and provide power for powering/charging the electronic device. For example, Power over Ethernet, Thunderbolt, etc. Equally, the interface could include separate power and data connections each configured according to separate standards, such as WiFi or Near-Field Communications (NFC) for data and an inductive charging standard (such as Qi) for power.

As well as incorporating the interface into an electrical wall outlet, such as electrical wall outlet 120, the interface could be incorporated into an electrical power outlet positioned anywhere inside or outside a building, or any other apparatus for connecting an electronic device to an electrical power source, such as an adapter for attaching an electronic device to an electrical power outlet (such as a plug-in adapter or extension lead).

The electrical wall outlet 120 has a communication device 140 which establishes a communication link (such as over a wired or wireless network) with a remote host 150. The communication device 140 sends the information identifying the smartphone 110, such as the Device Descriptors, to the remote host 150. The remote host 150 is “remote” in the sense that it is not located in the electrical wall outlet 120 but is a separate entity located at a distance from the electrical wall outlet 120 and connected via the communication link. The remote host may be located either in the same building or premises as the interface (connected to other interfaces in the building or premises) or located centrally (for example, in the cloud) where it may serve interfaces in multiple buildings, premises or locations. Where the remote host is located centrally, an optional hub 145 may be provided in the same building or premises as the interface or connected to the same local network as the interface to relay identification information to the remote host 150 which allows, for example, the communication device 140 and the hub 145 to communicate over a frequency suitable for low power and long distance communication rather than WiFi.

The electrical wall outlet 120 has an electronic switch 135 located between the transformer or power supply 130 and the USB interface 128, to control the supply of electrical power to the USB interface 128 (and hence the supply of electrical power for powering/charging the smartphone 110 connected to the USB interface 128). The electronic switch 135 is controlled by a control signal received from the remote host 150 by the communication device 140. Where the control signal indicates that operation of the smartphone 110 is allowed, the switch 135 may be enabled to supply electrical power to the smartphone 110. Where the control signal indicates that operation of the smartphone 110 is disallowed, the switch 135 may be disabled to prevent the supply electrical power to the smartphone 110.

The remote host 150 has a processor 152 which generates the control signal taking into account the identity of the smartphone 110 received from the electrical wall outlet 120, for example, considering whether the smartphone 110 is allowed to access electrical power from the electrical wall outlet 120.

The remote host has a storage medium 155 which stores a policy database which may include a policy associated with the smartphone 110 (for example, allowing or disallowing operation of the smartphone 110, allowing operation of the smartphone 110 only for a particular length of time or at particular times of day and/or days of the week). The policy may also be associated with the class of electronic devices to which the smartphone 110 belongs. For example, the class may be mobile phones or portable electronic devices and apply to all devices in that class. Where there is both a device specific policy and a class policy, one policy may take priority. For example, a class policy may indicate that mobile devices are not allowed to receive electrical power from electrical wall outlet 120 but a device specific policy may indicate that the smartphone 110 is allowed to receive electrical power from electrical wall outlet 120 which may override the class policy.

The USB data connection between the USB interface 128 and the smartphone 110 can be used to transfer additional data as well as just information identifying the smartphone 110. For example, information about the status of the smartphone 110 may also be retrieved by the USB interface 128 (such as a charging state of a battery of the smartphone 110 and/or a level of charge of the battery). The control signal may be generated based on the status of the smartphone 110, for example, to disable the switch 135 to turn off the supply of electrical power to the interface 128 when the smartphone 110 has finished charging.

In some cases, the USB interface 128 may not be able to establish a data connection with the connected electronic device or cannot retrieve any device identification information from the connected electronic device. This may happen where the USB interface of the connected electronic device does not have the ability to transfer data, such as on an electronic device where the USB interface is designed solely for charging (like a portable battery pack). The policy may indicate what action to take in cases where a data connection cannot be established or where device identification information cannot be retrieved.

One option is to disallow operation of the electronic device when no data connection can be established or no identification information is received, or to restrict access such as to a limited time window (such as only allowing one hour of electrical power).

Another option is to try to use an alternative way to identify the electronic device. The USB interface of a connected electronic device draws direct current (DC) for powering/charging the electronic device, so there will be no electrical waveform to modify which can form an electrical signature for identifying the electronic device. However, the electronic device will have a particular electrical demand (such as draw a particular current) which can be detected by a current sensor in the electrical wall outlets 120 and which may be used to distinguish between different electrical devices (for example, distinguishing a device that usually draws 500 mA from a device that usually draws 1 A). The electrical demand may be measured instantaneously or over a period of time. The electrical demand measured over time may be illustrative of an electrical demand profile during charging of the electronic device which may be distinctive to the particular electronic device. The interface may send the electrical demand profile to the remote host and the remote host may identify the electronic device based on the electrical demand profile (either alone or in combination with other identifying information, if available).

A user device 160 (such as a switch, control panel, portable electronic device, computer, tablet or smartphone) with a wireless transceiver 162 may receive information about electronic devices (such as smartphone 110) connected to electrical wall outlets 120 from the remote host 150 (via the hub 145 if present). The user device 160 has a display 164 for displaying this information. The information may include a list or graphical representation of all of the electrical wall outlets 120 in a building along with details of any electronic devices currently connected to them, optionally with information about their status (such as “charging” or “turned on”). A user may control any of the electronic devices, such as smartphone 110, from the user device 160 by selecting options relating to any of the electronic devices (for example, using a touchscreen display). The user’s selection causes the user device 160 to generate a control signal which is sent to the electrical wall outlet 120 via the remote host 150 and/or hub 145 to control the switch 135 to control electrical power to the electronic device.

Each USB interface 128 may have an associated interface identifier. The USB interface 128 may send the interface identifier to the remote host 150 and the remote host 150 may associate the identification information about the electronic device connected to the USB interface 128 with the interface identifier. The interface identifier may be associated with a particular location in a building or premises, such as a particular room or location in a room. This allows, for example, the user to see, from their user device 160, which room in a building a particular device is located.

The remote host 150 may store, on its storage medium 155, a device database containing data associated with any electronic devices connected to the USB interface 128. For example, the communications device 140 in the electrical wall outlet 120 sends the remote host 150 information identifying that smartphone 110 has been connected to the USB interface 128 and the remote host 150 may make a record indicating the time and date the smartphone 110 was connected, and may subsequently record when the smartphone is disconnected to form a record of the usage of the smartphone 110. Other data may also be recorded while the smartphone 110 is connected, such as an electrical demand profile (electrical demand, such as current drawn instantaneously or over a period of time), charge/discharge profiles, records of control signals sent to the smartphone 110, data received from the smartphone 110 (including one or more of error messages, status information, battery status, and charging information), electronic device identifiers for the smartphone 110 (including one or more of make, model, serial number, and user information), and so on. The remote host 150 may also store a record of each time an unidentified device has been connected to the interface.

The remote host 150 may execute, using its processor 152, an algorithm configured to generate predictions based on the data in the device database. The remote host 150 may then control devices connected to the system 100 (such as the smartphone 110) based on the predictions. Any or all of the data associated with electronic devices connected to the interface may be used to analyse and learn the behaviour and usage of the system 100, for example, to make predictions about future usage which can be used to control the system 100 more intelligently. The predictions can be used to generate future actions and policies to control devices connected to the system 100, such as the smartphone 110. For example, where usage data shows that smartphone 110 is usually turned off at midnight, the remote host 150 may predict that the smartphone 110 should be turned off whenever it has been left on after midnight and generate a control signal to switch 135 to turn off the power to the smartphone 110 automatically.

The algorithms may involve statistical analysis, predictive algorithms, artificial intelligence, machine learning and the like. The data associated with electronic devices connected to the interface can provide training data for training a machine learning (or other artificial intelligence algorithm) to make predictions about future behaviour which can be used to operate electronic or other electrical devices connected to the system 100 in an intelligent way

The remote host 150 may collect data associated with electronic devices connected to interfaces located in multiple locations (such as different buildings). For example, the hub 145 in each location may collect data associated with electronic device connected to interface(s) located in that particular location and share this with the remote host 150 in communication with hubs 145 in some or all of the locations. The algorithm may generate predictions based on data collected from multiple locations in order to improve the quality of predictions (for example, by increasing the size of the dataset)

Many electronic devices (such as televisions, computers, laptop, Hi-Fis, media units) have a USB interface which can be used for powering/charging other electronic devices as well as communications devices for receiving data (such as streaming media, software updates, etc). These electronic device can be designed or modified to identify and control electronic devices attached to their USB interface.

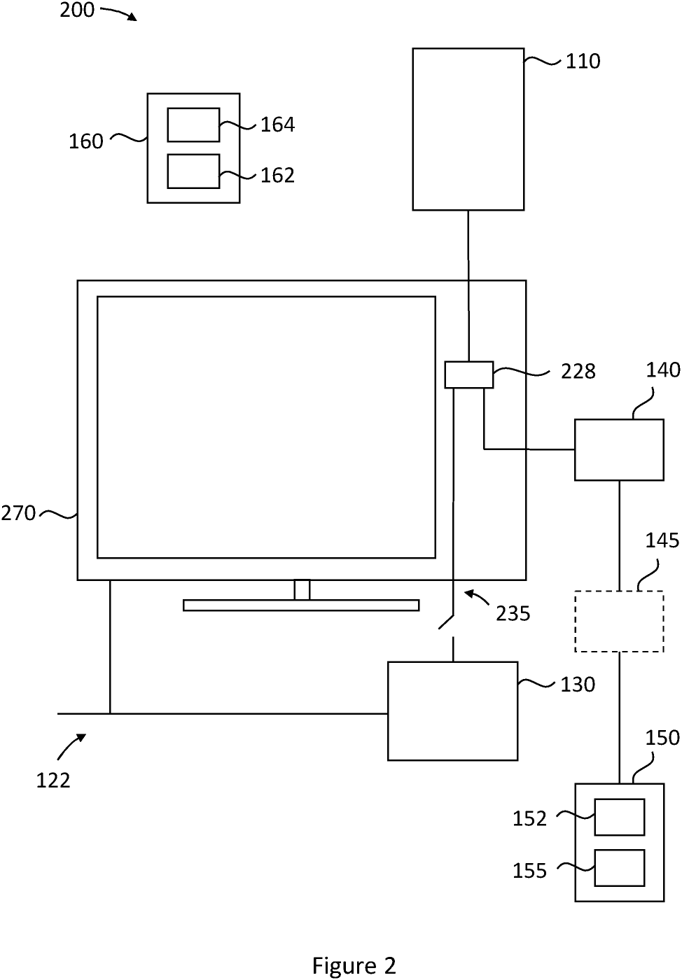

FIG. 2 shows an example of a television 270 which has a USB interface 228 to which smartphone 110 has been connected for powering/charging the smartphone 110. The data connection on USB interface 228 can be used to identify the smartphone 110 in much the same way as the electrical wall socket 120 identified the smartphone 110 in FIG. 1. The television 270 may have been specifically designed to identify the smartphone 110, report the identity to remote host 150 and control the electrical power supplied to the smartphone 110 based on control signals received from the remote hub 150, in much the same way as the electrical wall socket 120 described in FIG. 1. Alternatively, the television 270 may have received a software update (such as a firmware update or app downloaded from a website or app store on the television 270) which has programmed the USB interface 228 to identify the smartphone 110, report the identity to remote hub 150 and receive control signals from the remote hub 150 to control whether the USB interface 228 is to provide electrical power 228 to the smartphone 110.

Although the example in FIG. 2 shows a television 270, any other electronic device which has a USB interface could be used so long as it can provide power and communicate data over its USB connection and has the necessary processing and communications hardware to allow it to be configured to communicate with the remote hub and act on control signals received from the remote hub. The television 270, or any other electronic device, can have any or all of the features described in relation to the electrical wall socket 120 in FIG. 1.

1. A system for identifying an electronic device connected to an electrical power source, the system comprising an plurality of apparatuses configured to communicate with a remote host;
wherein each apparatus of the plurality of apparatuses comprise:
an interface having an interface identifier the interface configured to,
receive electrical power from an electrical power source, the interface being connectable to an electronic device to: provide electrical power from the electrical power source to the electronic device; and
emulate a computer interface according to a standard for connecting an electronic device to a computer, there by causing an electronic device connected to the interface to send a device identifier according to the standard; and
receive, from the electronic device inresponse to connectingthe electronic device to the interface, a device identifier identifying the electronic device according to the standard; and
a communication device configured to send the device identifier and the interface identifierto the remote host; and
the remote host comprising:
a communication device configured to receive the device identifier and corresponding interface identifier associated with an electronic device connected to an interface of the plurality of apparatuses,and
a processor configured to generate a control signal to control an electronic device associated with a selected device identifier connected to an interface having a corresponding interface identifier
wherein each apparatus further comprises a switch configured to control a supply of electrical power to a conncected electronic device based on the control signal received from the remote host.

2. The system of claim 1, wherein each apparatus is one of: an electrical power outlet, an adapter for attaching to an electrical power outlet, and a further electronic device.

3. (canceled)

4. (canceled)

5. (canceled)

6. The system of claim 1, wherein the standard is a Universal Serial Bus (USB) standard, each interface comprises a USB connector and is configured to emulate a USB host and each device identifier comprises a device descriptor according to the USB standard.

7. (canceled)

8. (canceled)

9. (canceled)

10. The system of claim 1, wherein the remote host is one or more of: in the same building as the interfaces, connected to the same local network as the interface, on a central server serving interfaces in multiple locations, connected to the interfaces over a wide area network, and in the cloud.

11. (canceled)

12. The system of claim 1, wherein the remote host comprises a computer-readable storage medium configured to store a policy database comprising a policy associated with electronic devices and/or a policy associated with a class of electronic devices; wherein
the control signal is generated based on the policy: and
in the event that the policy indicates that operation of the electronic device having the selected device identifier is allowed, the control signal is configured to enable the switch in the interface to which the electronic device having the selected device identifier is connected: and
in the event that the policy indicates that operation of the electronic device having the selected device identifier is disallowed, the control signal is configured to disable the switch in the interface to which the electronic device having the selected device identifier is connected.

13. (canceled)

14. (canceled)

15. (canceled)

16. (canceled)

17. The system of claim 1, wherein the control signal is configured to disallow operation of the electronic device having the selected device identifier in response to the interface receiving no identifier from the electronic device.

18. The system of claim 1, wherein each apparatus is configured to determine an electrical demand profile of an electronic device connected to the interface, wherein the comminication device of the apparatus sends the electrical demand profile to the remote host and the remote host is configured to identify the electronic device based on the electrical demand profile, wherein the apparatus determines an electrical demand profile in response to the interface receiving no device identifier from the connected electronic device.

19. (canceled)

20. (canceled)

21. (canceled)

22. The system of claim 1, further comprising a user device configured to receive information about connected electronic devices from the remote host, wherein the user device is, for example: a switch, a control panel, a portable electronic device, a computer, a tablet and a smartphone.

23. (canceled)

24. (canceled)

25. (canceled)

26. The system of claim 1, wherein at least one apparatus of the plurality of apparatuses comprises a further electronic device comprising the interface.

27. The system of claim 26, wherein the further electronic device is a computer, television, or media device.

28. The system of claim 27, wherein the further electronic device is configured to control electrical power to its interface based on a control signal from the remote host.

29. The system of claim 28, wherein the further electronic device is configured to receive a software update with instructions to allow the further electronic device to control the electrical power to its interface based on the control signal.

30. (canceled)

31. (canceled)

32. An apparatus for identifying an electronic device connected to an electrical power source, the apparatus comprising:
an interface having an interface identifier, the interface configured to:
receive electrical power from an electrical power source, the interface being connectable to an electronic device to:
provide electrical power from the electrical power source to the electronic device; and
emulate a computer interface according to a standard for connecting an electronic device to a computer, thereby causing an electronic device connected to the interface to send a device identifier according to the standard; and
receive, from the electronic device in response to connecting the electronic device to the interface, a device identifier identifying the electronic device according to the standard;
a communication device configured to:
send the device identifier and the interface identifier to a remote host, and
receive, from the remote host, a control signal configured to control the electronic device having the device identifier and the interface identifier; and
a switch configured to control a supply of electrical power to the electronic device based on the control signal.

33. The apparatus of claim 32, wherein the apparatus comprising the interface is one of: an electrical power outlet, an adapter for attaching to an electrical power, and a further electronic device.

34. (canceled)

35. (canceled)

36. (canceled)

37. The apparatus of clain 32, wherein the standard is a Universal Serial Bus (USB) standard, the interface comprises a USB connector and is configured to emulate a USB host and the device identifier comprises a device descriptor according to the USB standard.

38. The apparatus of claims 32, wherein the interface is configured to determine an electrical demand profile of the electronic device, wherein the interface determines an electrical demand profile in response to the interface receiving no device identifier from the electronic device.

39. (canceled)

40. The apparatus of claim 32, wherein the apparatus comprising the interface is a further electronic device.

41. The apparatus of claim 40, wherein the further electronic device is configured to receive a software update with instructions to allow the further electronic device to control the electrical power to the electronic device connected to the interface based on the control signal.

42. (canceled)
